(19) United States
(12) Patent Application Publication
(10) Pub. No.: US 2023/0162462 A1
(43) Pub. Date: May 25, 2023

(54) IMAGE PROCESSING SYSTEM CAPABLE OF READING INFORMATION FROM INFORMATION CODE, AND INFORMATION CODE READING METHOD

(71) Applicant: KYOCERA Document Solutions Inc., Osaka (JP)

(72) Inventor: Yasuyoshi Kobayashi, Osaka (JP)

(21) Appl. No.: 18/057,167

(22) Filed: Nov. 18, 2022

(30) Foreign Application Priority Data
Nov. 24, 2021 (JP) 2021-189946

(51) Int. Cl. G06V 10/12; G06V 10/98

(52) U.S. Cl. CPC G06V 10/12; G06V 10/993; G06V 2201/07

(57) ABSTRACT

An image processing system includes a detection processing portion, a first correction processing portion, and a reading processing portion. The detection processing portion detects an outline of an information code included in a captured image. The first correction processing portion corrects a shape of the information code based on the outline of the information code detected by the detection processing portion. The reading processing portion reads information included in the information code from the information code after correction by the first correction processing portion.

INCORPORATION BY REFERENCE

This application is based upon and claims the benefit of priority from the corresponding Japanese Patent Application No. 2021-189946 filed on Nov. 24, 2021, the entire contents of which are incorporated herein by reference.

### BACKGROUND

The present disclosure relates to an image processing system and an information code reading method.

An image processing apparatus is known that reads information included in an information code, such as a two-dimensional code, from a captured image of the information code.

### SUMMARY

An image processing system according to an aspect of the present disclosure includes a detection processing portion, a first correction processing portion, and a reading processing portion. The detection processing portion detects an outline of an information code included in a captured image. The first correction processing portion corrects a shape of the information code based on the outline of the information code detected by the detection processing portion. The reading processing portion reads information included in the information code from the information code after correction by the first correction processing portion.

An information code reading method according to another aspect of the present disclosure includes a detection step, a correction step, and a reading step. In the detection step, an outline of an information code included in a captured image is detected. In the correction step, a shape of the information code is corrected based on the outline of the information code detected by the detection step. In the reading step, information included in the information code is read from the information code after correction by the correction step.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram showing a functional configuration of an image processing system of an embodiment according to the present disclosure.

FIG. 2 is a block diagram showing a hardware configuration of a mobile terminal included in an image processing system of an embodiment according to the present disclosure.

FIG. 3 is a block diagram showing a hardware configuration of an image forming apparatus included in an image processing system of an embodiment according to the present disclosure.

FIG. 4 is a diagram showing an example of a captured image acquired by an image processing system of an embodiment according to the present disclosure.

FIG. 5 is a diagram showing an example of a captured image acquired by an image processing system of an embodiment according to the present disclosure.

FIG. 6 is a diagram showing an example of a reception screen displayed by an image processing system of an embodiment according to the present disclosure.

FIG. 7 is a flowchart showing an example of a first information code reading process executed by an image processing system of an embodiment according to the present disclosure.

FIG. 8 is a flowchart showing an example of a second information code reading process executed by an image processing system of an embodiment according to the present disclosure.

FIG. 9 is a flowchart showing an example of a third information code reading process executed by an image processing system of an embodiment according to the present disclosure.

### DETAILED DESCRIPTION

Embodiments according to the present disclosure will be described below with reference to the accompanying drawings. Note that the following embodiments are examples of implementing techniques according to the present disclosure and do not limit the technical scope of the present disclosure.

[Image Processing System 100]

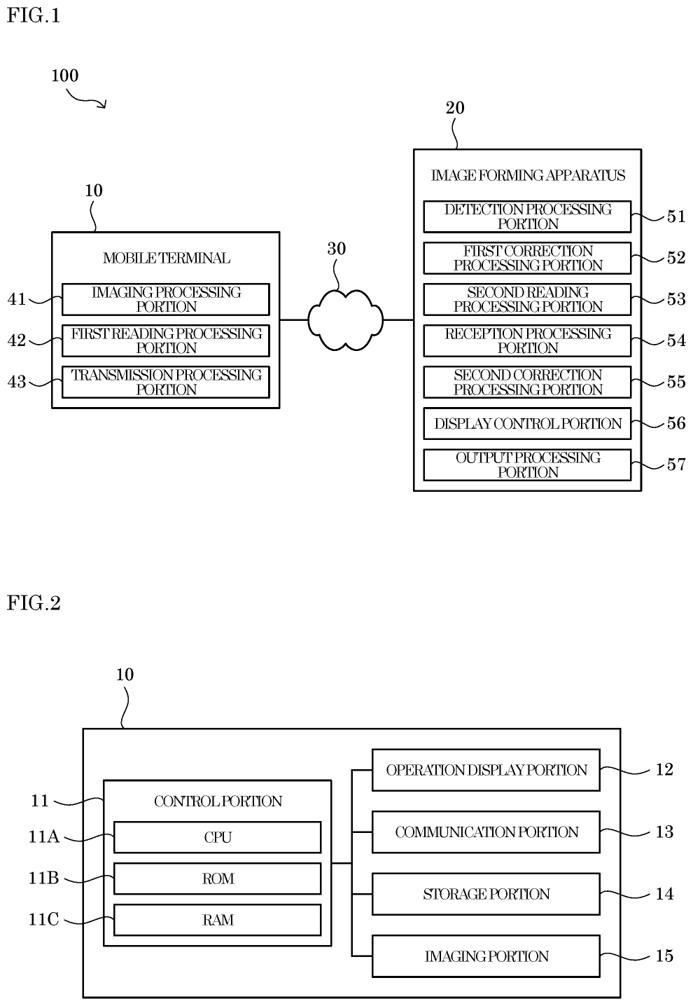

First, an image processing system 100 of an embodiment according to the present disclosure will be described with reference to FIG. 1.

The image processing system 100 reads information included in an information code (hereinafter referred to as “reading target information”) from a captured image of the information code.

For example, the information code is a QR code. Note that the information code may be a two-dimensional code different from a QR code. In addition, the information code may be a one-dimensional code such as a bar code. Further, the information code may be a multidimensional code including the reading target information.

As shown in FIG. 1, the image processing system 100 includes a mobile terminal 10 and an image forming apparatus 20. In the image processing system 100, the mobile terminal 10 and the image forming apparatus 20 are connected via a communication network 30 so as to be able to communicate with each other (see FIG. 1). For example, the communication network 30 is the Internet or a local area network (LAN). Note that the mobile terminal 10 and the image forming apparatus 20 may perform wireless communication according to a communication standard such as Bluetooth.

[Hardware Configuration of Image Processing System 100]

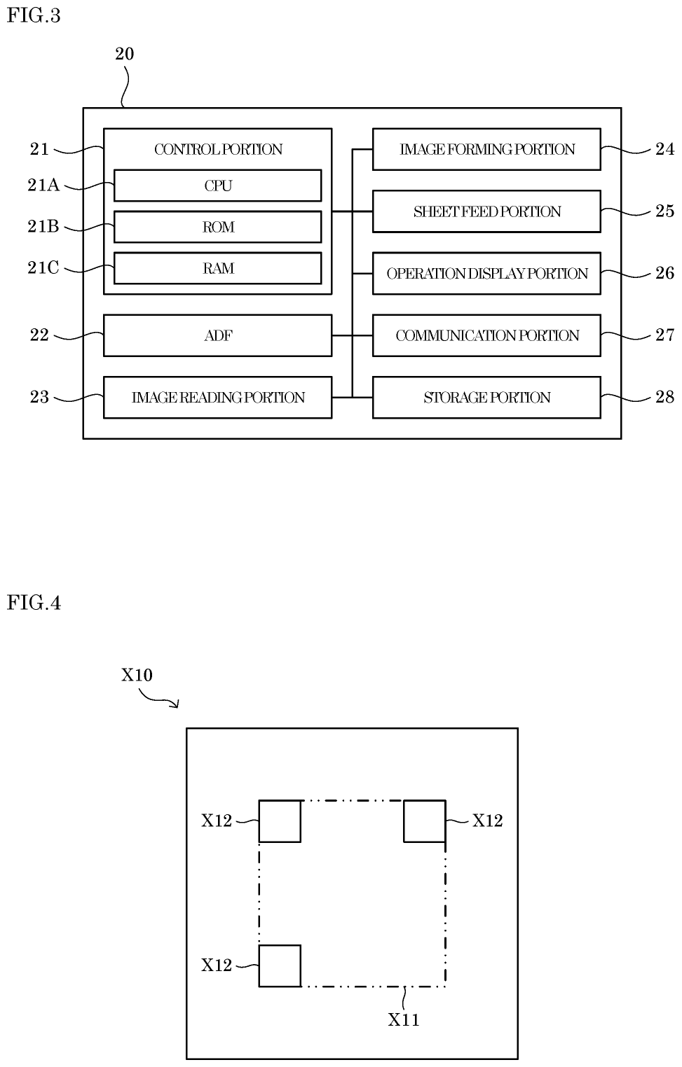

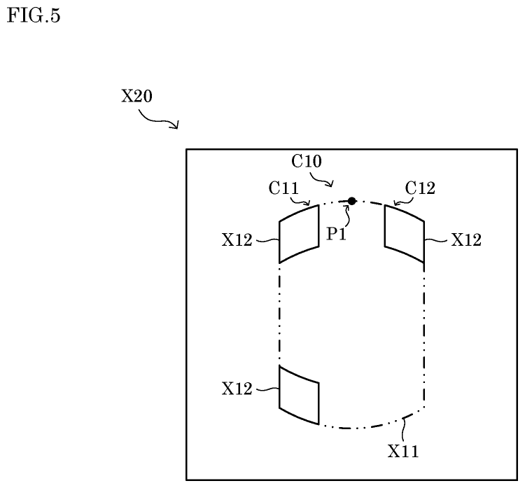

Next, a hardware configuration of the image processing system 100 will be described with reference to FIG. 2 and FIG. 3.

The mobile terminal 10 is a device having a camera function for acquiring a captured image of a subject. For example, the mobile terminal 10 is a smartphone or a tablet terminal. Note that the mobile terminal 10 may be a digital camera or the like.

As shown in FIG. 2, the mobile terminal 10 includes a control portion 11, an operation display portion 12, a communication portion 13, a storage portion 14, and an imaging portion 15.

The control portion 11 performs overall control of the mobile terminal 10. As shown in FIG. 2, the control portion 11 includes a CPU 11A, a ROM 11B, and a RAM 11C. The CPU 11A is a processor that executes various types of arithmetic processes. The ROM 11B is a non-volatile storage device in which information such as a control program for causing the CPU 11A to execute various types of processes is stored in advance. The RAM 11C is a volatile or non-volatile storage device used as a temporary storage memory (work area) for various types of processes executed by the CPU 11A. The CPU 11A executes various types of control programs stored in advance in the ROM 11B. Thus, overall control of the mobile terminal 10 is performed.

The operation display portion 12 is a user interface of the mobile terminal 10. The operation display portion 12 has a display portion and an operation portion. The display portion displays various types of information according to control instructions from the control portion 11. For example, the display portion is a liquid crystal display. The operation portion inputs various types of information to the control portion 11 according to user operations. For example, the operation portion is a touch panel.

The communication portion 13 is a communication interface that performs wired or wireless data communication with an external communication device such as the image forming apparatus 20 via the communication network 30.

The storage portion 14 is a non-volatile storage device. For example, the storage portion 14 is a non-volatile memory such as a flash memory.

The imaging portion 15 achieves a camera function. The imaging portion 15 includes a camera for capturing an image of a subject. The imaging portion 15 outputs image data representing a captured image of a subject. Image data output from the imaging portion 15 is input to the control portion 11.

The image forming apparatus 20 is an apparatus having a printing function that forms an image based on image data. For example, the image forming apparatus 20 is a multifunction peripheral having multiple functions including the printing function. Note that the image forming apparatus 20 may be a printer, a facsimile machine, a copier, or the like.

As shown in FIG. 3, the image forming apparatus 20 includes a control portion 21, an ADF 22, an image reading portion 23, an image forming portion 24, a sheet feed portion 25, an operation display portion 26, a communication portion 27, and a storage portion 28.

The control portion 21 performs overall control of the image forming apparatus 20. As shown in FIG. 3, the control portion 21 includes a CPU 21A, a ROM 21B, and a RAM 21C. The CPU 21A, ROM 21B, and RAM 21C include the same functions as the CPU 11A, ROM 11B, and RAM 11C of the mobile terminal 10.

The ADF 22 conveys a document sheet whose image is to be read by the image reading portion 23. The ADF 22 includes a document sheet setting portion, a plurality of conveying rollers, a document sheet holder, and sheet discharge portion.

The image reading portion 23 reads image data of a document sheet. The image reading portion 23 includes a document sheet table, a light source, a plurality of mirrors, an optical lens, and a CCD.

The image forming portion 24 achieves the printing function. For example, the image forming portion 24 forms an image on a sheet supplied by the sheet feed portion 25 using an electrophotographic method. For example, the image forming portion 24 includes a plurality of image forming units, a laser scanning unit, an intermediate transfer belt, a secondary transfer roller, a fixing device, and a sheet discharge tray.

The sheet feed portion 25 supplies sheets to the image forming portion 24. The sheet feed portion 25 includes a sheet feed cassette, a manual feed tray, and a plurality of conveying rollers.

The operation display portion 26 is a user interface of the image forming apparatus 20. For example, the operation display portion 26 has the same configuration as the operation display portion 12 of the mobile terminal 10.

The communication portion 27 is a communication interface that performs wired or wireless data communication with an external communication device such as the mobile terminal 10 via the communication network 30.

The storage portion 28 is a non-volatile storage device. For example, the storage portion 28 is a storage device such as a solid state drive (SSD) or a hard disk drive (HDD).

[Functional Configuration of Image Processing System 100]

Next, a functional configuration of the image processing system 100 will be described with reference to FIG. 1.

In the image processing system 100, the mobile terminal 10 is used for capturing an image of the information code and reading the reading target information from the captured information code.

More specifically, as shown in FIG. 1, the mobile terminal 10 includes an imaging processing portion 41, a first reading processing portion 42, and a transmission processing portion 43.

For example, the storage portion 14 of the mobile terminal 10 stores in advance a first information code reading program for causing the control portion 11 to function as each of the above-described portions. The CPU 11A of the control portion 11 functions as each of the above-described portions by executing the first information code reading program. Note that part or all of the imaging processing portion 41, the first reading processing portion 42, and the transmission processing portion 43 may be achieved by an electronic circuit such as an ASIC.

The imaging processing portion 41 causes the imaging portion 15 to output a captured image of a subject, and causes the operation display portion 12 to display the captured image.

More specifically, the imaging processing portion 41 causes the imaging portion 15 to output a captured image of a subject and causes the operation display portion 12 to display the captured image at a predetermined output interval.

Here, FIG. 4 shows a captured image X10, which is an example of a captured image of a subject output from the imaging portion 15. The captured image X10 is an image including a QR code X11 as a subject. Note that in FIG. 4, the QR code X11 is shown as an area surrounded by a two-dot chain line.

The QR code X11 includes three positioning markers X12. Each positioning marker X12 is an image composed of a black square and a square-shaped black frame surrounding the square. The three positioning markers X12 are arranged at three of the four corners of the QR code X11 (upper right corner, upper left corner, lower left corner). The three positioning markers X12 are used to identify the position and orientation of the QR code X11 in the captured image of the QR code X11. Note that, in FIG. 4, each positioning marker X12 is shown in a simplified manner.

The first reading processing portion 42 executes a first reading process of reading the reading target information included in the information code based on the captured image of the information code output from the imaging portion 15.

For example, in a case where a captured image of a subject is output from the imaging portion 15, the first reading processing portion 42, based on a detection result of the positioning markers X12 (see FIG. 4) from the captured image, identifies the QR code X11 (see FIG. 4) included in the captured image. In a case where the QR code X11 included in the captured image output from the imaging portion 15 is identified, the first reading processing portion 42 reads the reading target information from the QR code X11.

In some cases the information code may be attached to a cylindrical object such as a plastic bottle or a utility pole. When the information code is attached to a cylindrical object, the shape of the information code may become distorted, and reading of the reading target information from the captured image of the information code may fail. In addition, a similar problem also occurs in a case where the information code is attached to a spherical object.

Here, FIG. 5 shows a captured image X20, which is another example of a captured image of a subject output from the imaging portion 15. The captured image X20 is an image including a QR code X11 attached to a cylindrical object as a subject. As shown in FIG. 5, in a case where the QR code X11 is attached to a cylindrical object, the shape of the QR code X11 will be distorted. When the degree of the distortion is large, the positioning markers X12 cannot be detected, and reading of the reading target information by the first reading processing portion 42 fails.

On the other hand, in the image processing system 100 of this embodiment according to the present disclosure, it is possible to read the reading target information included in the information code from the distorted information code as will be described below.

The transmission processing portion 43 transmits the captured image output from the imaging portion 15 to the image forming apparatus 20.

For example, the transmission processing portion 43 transmits the captured image output from the imaging portion 15 to the image forming apparatus 20 when a predetermined transmission operation is performed. For example, the transmission operation is an operation on predetermined soft keys or hard keys.

For example, the transmission processing portion 43 transmits the captured image (still image) output from the imaging portion 15 at timing when the transmission operation is performed.

In the image processing system 100, the image forming apparatus 20 is used to correct the shape of the information code transmitted from the mobile terminal 10, and to read the reading target information from the information code after shape correction has been performed.

More specifically, as shown in FIG. 1, the image forming apparatus 20 includes a detection processing portion 51, a first correction processing portion 52, a second reading processing portion 53, a reception processing portion 54, a second correction processing portion 55, a display control portion 56, and an output processing portion 57.

For example, the storage portion 28 of the image forming apparatus 20 stores in advance a second information code reading program for causing the control portion 21 to function as each of the above-described portions. The CPU 21A of the control portion 21 functions as each of the above-described portions by executing the second information code reading program. Note that a part or all of the detection processing portion 51, the first correction processing portion 52, the second reading processing portion 53, the reception processing portion 54, the second correction processing portion 55, the display control portion 56, and the output processing portion 57 may be achieved by an electronic circuit such as an ASIC.

The detection processing portion 51 detects an outline of the information code included in the captured image.

More specifically, the detection processing portion 51 detects the outline of the information code included in the captured image transmitted from the mobile terminal 10.

For example, the detection processing portion 51 detects three distorted positioning markers X12 (see FIG. 5) included in the captured image. For example, the detection processing portion 51, of areas surrounded by black lines included in the captured image, detects three areas of the same or similar size arranged in the shape of a right triangle as three distorted positioning markers X12.

The detection processing portion 51 detects the outline of the QR code X11 (see the two-dot chain line in FIG. 5) based on the detected three distorted positioning markers X12.

The first correction processing portion 52 corrects the shape of the information code based on the outline of the information code detected by the detection processing portion 51.

More specifically, the first correction processing portion 52 corrects the shape of the information code based on part of the outline of the information code.

For example, the first correction processing portion 52 calculates mathematical expressions representing curved lines for each of two partial curved portions C11 and C12 (see FIG. 5) included in the outline of the QR code X11. The two partial curved portions C11 and C12 are obtained by dividing a curved portion C10 (see FIG. 5) included in the outline of the QR code X11 at a vertex P1 (see FIG. 5) of the curved portion C10. The first correction processing portion 52, based on two mathematical expressions corresponding to the calculated two partial curved portions C11 and C12, corrects the shape of the QR code X11 so that the QR code X11 has a square shape.

Note that a plurality of sample images each showing the outline of the information code and having different degrees of distortion may be stored in advance in the storage portion 28. In this case, the first correction processing portion 52 may use correction data corresponding to the sample image of the plurality of sample images having the highest matching rate with the outline of the information code detected by the detection processing portion 51, and correct the shape of the information code so that the information code has a rectangular shape. In addition, the first correction processing portion 52 may use a known algorithm to correct the shape of the information code so that the information code has a rectangular shape.

The second reading processing portion 53 executes a second reading process of reading the reading target information included in the information code from the information code after correction by the first correction processing portion 52. The second reading processing portion 53 is an example of a reading processing portion according to the present disclosure.

The second reading process may be a process having the same content as the first reading process.

In a case where reading of the reading target information from the information code after correction by the first correction processing portion 52 fails, the reception processing portion 54 displays a reception screen including the information code, and receives a predetermined correction operation on the reception screen.

More specifically, the reception processing portion 54 displays the reception screen including the information code selected by a predetermined selection operation of selecting one of the information code before correction by the first correction processing portion 52 and the information code after correction by the first correction processing portion 52.

For example, in a case where reading of the reading target information from the information code after correction by the first correction processing portion 52 fails, the reception processing portion 54 causes the operation display portion 26 to display a predetermined selection screen. On the selection screen, the information code before correction by the first correction processing portion 52 and the information code after correction by the first correction processing portion 52 are displayed in a selectable manner. An operation of selecting one of the information codes on the selection screen is the selection operation.

In a case where the selection operation is received on the selection screen, the reception processing portion 54 causes the operation display portion 26 to display the reception screen including the information code selected by the selection operation.

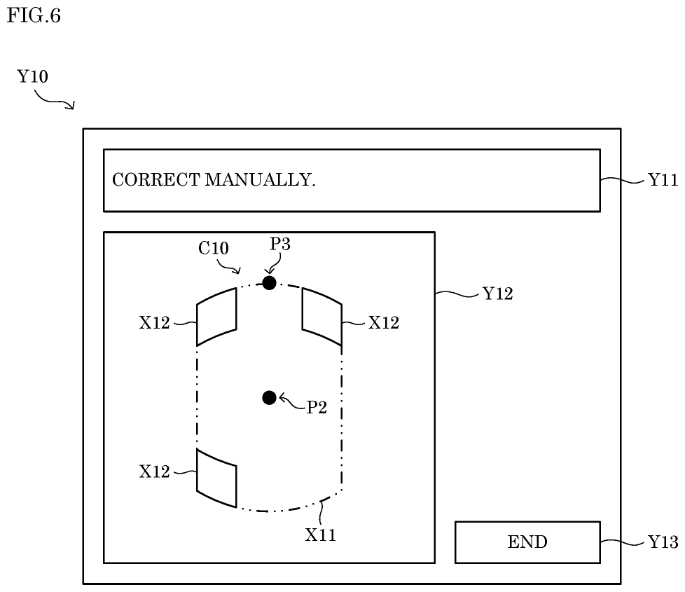

Here, FIG. 6 shows a reception screen Y10, which is an example of the reception screen caused to be displayed by the reception processing portion 54. The reception screen Y10 includes a message display field Y11, a captured image display field Y12, and an operation key Y13.

A message to the user of the image processing system 100 is displayed in the message display field Y11.

A captured image including the QR code X11 selected by the selection operation is displayed in the captured image display field Y12. The correction operation is received in captured image display field Y12.

For example, the correction operation is a pinch-out operation and a pinch-in operation in the captured image display field Y12. Note that the correction operation may be another touch operation in the captured image display field Y12. In addition, the correction operation is not limited to an operation performed in the captured image display field Y12, and may include any operation capable of transforming the shape of the information code included in the reception screen.

The operation key Y13 is an operation key used for an end operation for ending reception of the correction operation by the reception processing portion 54.

The second correction processing portion 55 corrects the shape of the information code according to the correction operation.

For example, it is presumed that in the captured image display field Y12 shown in FIG. 6, fingers are brought into contact with a position P2 (see FIG. 6) and a position P3 (see FIG. 6), and a pinch-in operation is performed by moving the finger at position P3 toward position P2 while keeping the finger at position P2 fixed. In this case, the second correction processing portion 55, according to the amount of movement of the finger at the position P3, executes image processing for deforming the image of the area including the position P3 so that the image moves toward the position P2.

In addition, it is presumed that in the captured image display field Y12 shown in FIG. 6, fingers are brought into contact with a position P2 (see FIG. 6) and a position P3 (see FIG. 6), and a pinch-out operation is performed by moving the finger at position P3 toward an opposite side from position P2 while keeping the finger at position P2 fixed. In this case, the second correction processing portion 55, according to the amount of movement of the finger at the position P3, executes image processing for deforming the image of the area including the position P3 so that the image moves away from the position P2.

The display control portion 56 reflects the information code after correction by the second correction processing portion 55 on the reception screen.

In a case where reading of the reading target information from the information code after correction by the first correction processing portion 52 fails, the second reading processing portion 53 executes a third reading process for reading the reading target information from the information code after correction by the second correction processing portion 55.

For example, the second reading processing portion 53 executes the third reading process in a case where an operation to the operation key Y13 is received on the reception screen Y10.

The third reading process may be a process having the same content as the first reading process.

In a case where reading of the reading target information by the second reading processing portion 53 is successful, the output processing portion 57 outputs the information code used for reading the information.

For example, the output processing portion 57 uses the image forming portion 24 to print the information code used for reading the reading target information. Note that printing of the information code may be executed according to a predetermined output operation.

Note that the output processing portion 57 may transmit an e-mail including the information code used for reading the reading target information to a predetermined destination. In addition, the output processing portion 57 may cause the operation display portion 26 to display the information code used for reading the reading target information.

[First Information Code Reading Process]

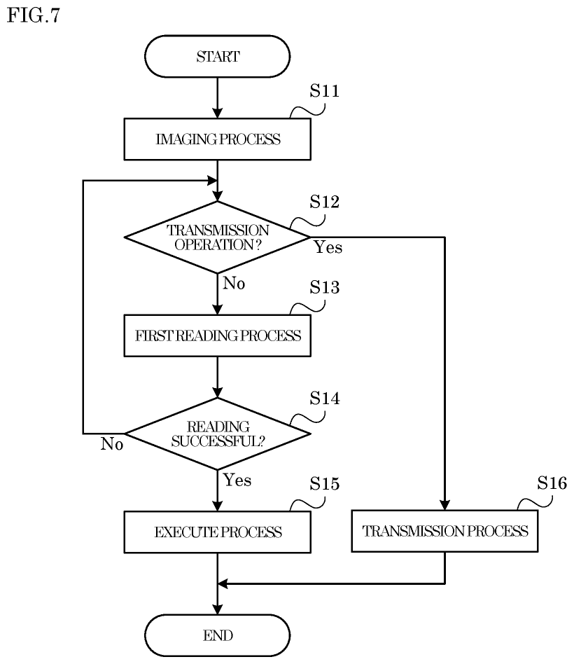

An example of a procedure of the first information code reading process executed by the control portion 11 of the mobile terminal 10 in the image processing system 100 will be described below with reference to FIG. 7. Here, steps S11, S12, and so on represent the number of the processing procedure (step) executed by the control portion 11. Note that the first information code reading process is executed in a case where an instruction to execute the first information code reading process is input by a user operation on the operation display portion 12.

<Step S11>

First, in step S11, the control portion 11 causes the imaging portion 15 to output a captured image of a subject and starts an imaging process for displaying the captured image on the operation display portion 12. Here, the processing in step S11 is executed by the imaging processing portion 41 of the control portion 11.

More specifically, the control portion 11 causes the imaging portion 15 to output the captured image of the subject and causes the operation display portion 12 to display the captured image at the output interval.

<Step S12>

In step S12, the control portion 11 determines whether or not the transmission operation was performed during execution of the imaging process.

Here, when the control portion 11 determines that the transmission operation has been performed (Yes in S12), the control portion 11 causes the processing to proceed to step S16. In addition, when the transmission operation has not been performed (No in S12), the control portion 11 causes the processing to proceed to step S13.

<Step S13>

In step S13, based on the captured image of the information code output from the imaging portion 15, the control portion 11 executes the first reading process of reading the reading target information included in the information code. Here, the processing in step S13 is executed by the first reading processing portion 42 of the control portion 11.

More specifically, the control portion 11 identifies the QR code X11 (see FIG. 4) included in the captured image based on the detection result of the positioning markers X12 (see FIG. 4) from the captured image output from the imaging portion 15. In a case where the QR code X11 included in the captured image output from the imaging portion 15 is identified, the control portion 11 reads the reading target information from the QR code X11.

<Step S14>

In step S14, the control portion 11 divides the process into branches depending on whether reading of the reading target information in the first reading process executed in step S13 succeeds or fails. More specifically, in a case where the reading target information is successfully read (Yes in S14), the control portion 11 causes the processing to proceed to step S15. In addition, in a case where reading of the reading target information fails (No in S14), the control portion 11 causes the processing to proceed to step S12. Thus, the imaging process is continued until the transmission operation is performed or the reading target information is successfully read.

<Step S15>

In step S15, the control portion 11 executes processing based on the reading target information read from the information code.

For example, in a case where the reading target information read from the information code is a URL, the control portion 11 ends the imaging process and causes the operation display portion 12 to display a website corresponding to the URL.

Note that the control portion 11 may cause the operation display portion 12 to display the reading target information read from the information code. In this case, the control portion 11 may cause the processing to proceed to step S12 and continue execution of the first information code reading process.

<Step S16>

In step S16, the control portion 11 executes a transmission process for transmitting the captured image output from the imaging portion 15 to the image forming apparatus 20. Here, the processing in step S16 is executed by the transmission processing portion 43 of the control portion 11.

More specifically, the control portion 11 transmits the captured image (still image) output from the imaging portion 15 at the timing when the transmission operation is performed.

[Second Information Code Reading Process]

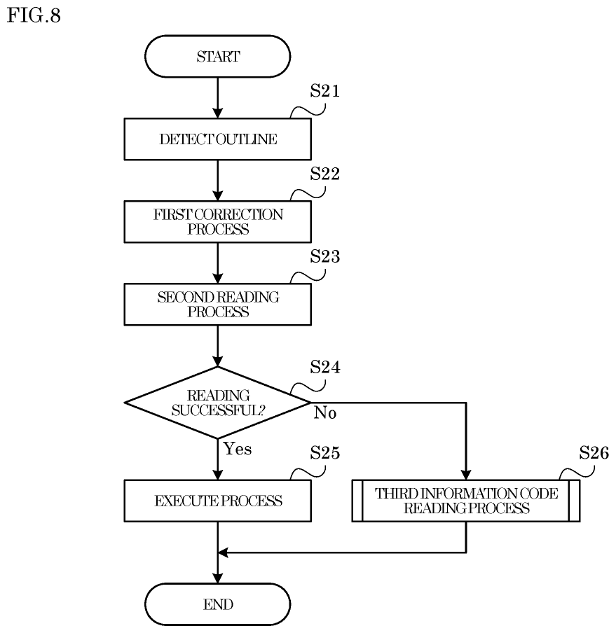

Next, with reference to FIG. 8, an information code reading method according to the present disclosure will be described together with an example of a procedure of the second information code reading process executed by the control portion 21 of the image forming apparatus 20 in the image processing system 100. Note that the second information code reading process is executed in a case where the image forming apparatus 20 receives a captured image transmitted from the mobile terminal 10 by the transmission process.

<Step S21>

First, in step S21, the control portion 21 detects an outline of the information code included in the captured image transmitted from the mobile terminal 10. Here, the processing in step S21 is an example of a detection step according to the present disclosure, and is executed by the detection processing portion 51 of the control portion 21.

More specifically, the control portion 21 detects three distorted positioning markers X12 (see FIG. 5) included in the captured image transmitted from the mobile terminal 10. The control portion 21 detects the outline of the QR code X11 (see the two-dot chain line in FIG. 5) based on the detected three distorted positioning markers X12.

<Step S22>

In step S22, the control portion 21 executes a first correction process for correcting a shape of the information code based on the outline of the information code detected in step S21. Here, the processing in step S22 is an example of a correction step according to the present disclosure, and is executed by the first correction processing portion 52 of the control portion 21.

For example, the control portion 21 calculates mathematical expressions representing curved lines for each of two partial curved portions C11 and C12 (see FIG. 5) included in the outline of the QR code X11. The control portion 21 corrects the shape of the QR code X11 based on two mathematical expressions corresponding to the two calculated partial curved portions C11 and C12.

<Step S23>

In step S23, the control portion 21 executes the second reading process of reading the reading target information included in the information code from the information code after the processing in step S22. Here, the processing in step S23 is an example of a reading step according to the present disclosure, and is executed by the second reading processing portion 53 of the control portion 21.

<Step S24>

In step S24, the control portion 21 divides the process into branches depending on whether reading of the reading target information in the second reading process executed in step S23 succeeds or fails. More specifically, in a case where the reading target information is successfully read (Yes in S24), the control portion 21 causes the processing to proceed to step S25. In addition, in a case where reading of the reading target information fails (No in S24), the control portion 21 causes the processing to proceed to step S26.

<Step S25>

In step S25, the control portion 21 executes processing based on the reading target information read from the information code.

For example, in a case where the reading target information read from the information code is a URL, the control portion 21 ends the imaging process and causes the operation display portion 12 to display a website corresponding to the URL.

Note that, in a case where the processing in step S25 is executed, the control portion 21 may print the information code used for reading the reading target information in accordance with the output operation. Thus, even an image processing system different from the image processing system 100, it is possible to read the reading target information. Here, the process of printing the information code is executed by the output processing portion 57 of the control portion 21.

<Step S26>

In step S26, the control portion 21 executes a third information code reading process described below.

[Third Information Code Reading Process]

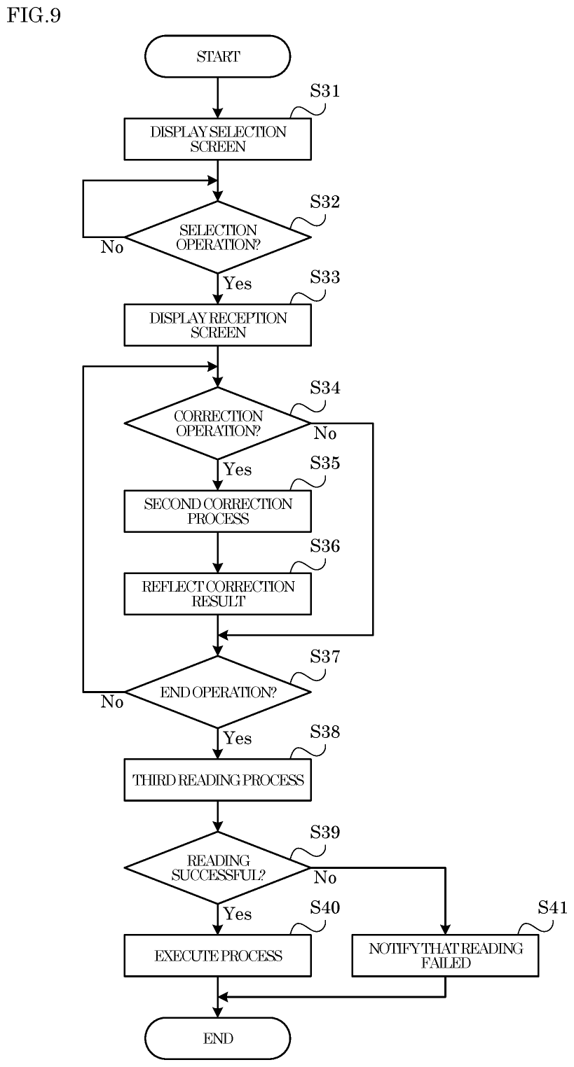

Next, the third information code reading process executed in step S26 of the second information code reading process will be described with reference to FIG. 9.

<Step S31>

First, in step S31, the control portion 21 causes the operation display portion 26 to display the selection screen including the information code before the processing in step S22 and the information code after the processing in step S22.

<Step S32>

In step S32, the control portion 21 determines whether or not the selection operation of selecting any of the information codes has been received on the selection screen displayed in step S31.

Here, when the control portion 21 determines that the selection operation has been received (Yes in S32), the control portion 21 causes the processing to proceed to step S33. In addition, when the selection operation has not been received (No in S32), the control portion 21 waits for the selection operation to be received in step S32.

Thus, on the reception screen, the user is able to display the information code of the information code before and after the correction that has been determined to require less operation for correction.

<Step S33>

In step S33, the control portion 21 causes the operation display portion 26 to display the reception screen. Here, the processing from step S31 to step S33 is executed by the reception processing portion 54 of the control portion 21.

<Step S34>

In step S34, the control portion 21 determines whether or not the correction operation has been performed on the reception screen displayed in step S33.

Here, when the control portion 21 determines that the correction operation has been performed (Yes in S34), the control portion 21 causes the processing to proceed to step S35. In addition, when the correction operation has not been performed (No in S34), the control portion 21 causes the processing to proceed to step S37.

<Step S35>

In step S35, the control portion 21 executes a second correction process for correcting the shape of the information code according to the correction operation. Here, the processing in step S35 is executed by the second correction processing portion 55 of the control portion 21.

Here, the correction operation is a touch operation on the captured image display field Y12. Thus, the user is able to correct the shape of the information code with an intuitive operation.

<Step S36>

In step S36, the control portion 21 reflects the information code after correction by the second correction process executed in step S35 on the reception screen. Here, the processing in step S36 is executed by the display control portion 56 of the control portion 21

Thus, the user is able to adjust the operation amount of the correction operation so that the information code displayed on the reception screen has a desired shape.

<Step S37>

In step S37, the control portion 21 determines whether or not the end operation has been performed on the reception screen displayed in step S33.

Here, when the control portion 21 determines that the end operation has been performed (Yes in S37), the control portion 21 causes the processing to proceed to step S38. In addition, when the end operation has not been performed (No in S37), the control portion 21 causes the processing to proceed to step S34.

<Step S38>

In step S38, the control portion 21 executes the third reading process of reading the reading target information from the information code after the processing in step S35. Here, the processing in step S38 is executed by the second reading processing portion 53 of the control portion 21.

<Step S39>

In step S39, the control portion 21 divides the process into branches depending on whether reading of the reading target information in the third reading process executed in step S38 succeeds or fails. More specifically, in a case where the reading target information is successfully read (Yes in S39), the control portion 21 causes the processing to proceed to step S40. In addition, in a case where reading of the reading target information fails (No in S39), the control portion 21 causes the processing to proceed to step S41.

<Step S40>

In step S40, the control portion 21 executes processing based on the reading target information read from the information code, as in step S25 by the second information code reading process.

<Step S41>

In step S41, the control portion 21 notifies that reading of the reading target information from the information code has failed.

For example, the control portion 21 causes the operation display portion 26 to display a message indicating that reading of the reading target information from the information code has failed.

As described above, in the image processing system 100, the shape of the information code is corrected based on the outline of the information code before the reading target information is read from the information code included in the captured image. Thus, it is possible to read the reading target information included in the information code from the distorted information code.

Note that the mobile terminal 10 may also include a detection processing portion 51, a first correction processing portion 52, a second reading processing portion 53, a reception processing portion 54, a second correction processing portion 55, a display control portion 56, and an output processing portion 57. The mobile terminal 10 including these portions is another example of the image processing system according to the present disclosure.

In addition, the image processing system 100 does not have to include the mobile terminal 10. In this case, the image forming apparatus 20 may be regarded as the image processing system according to the present disclosure.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An image processing system, comprising:
a detection processing portion configured to detect an outline of an information code included in a captured image;
a first correction processing portion configured to correct a shape of the information code based on the outline of the information code detected by the detection processing portion; and
a reading processing portion configured to read information included in the information code from the information code after correction by the first correction processing portion.

2. The image processing system according to claim 1, wherein
the first correction processing portion corrects the shape of the information code based on part of the outline of the information code.

3. The image processing system according to claim 1, further comprising:
a reception processing portion configured to display a reception screen including the information code and receive a predetermined correction operation on the reception screen in a case where reading of the information from the information code after correction by the first correction processing portion fails;
a second correction processing portion configured to correct the shape of the information code according to the correction operation; and
a display control portion configured to reflect the information code after correction by the second correction processing portion on the reception screen; wherein
the reading processing portion reads the information from the information code after correction by the second correction processing portion in a case where reading of the information from the information code after correction by the first correction processing portion fails.

4. The image processing system according to claim 3, wherein
the correction operation includes a touch operation on the reception screen.

5. The image processing system according to claim 3, wherein
the reception processing portion causes the reception screen including one of the information code before correction by the first correction processing portion and the information code after correction by the first correction processing portion selected by a predetermined selection operation to be displayed.

6. The image processing system according to claim 1, further comprising
an output processing portion configured to output the information code used for reading the information in a case where the information is successfully read by the reading processing portion.

7. An information code reading method comprising:
a detection step of detecting an outline of an information code included in a captured image;
a correction step of correcting a shape of the information code based on the outline of the information code detected by the detection step; and
a reading step of reading information included in the information code from the information code after correction by the correction step.
